(19) United States
(12) Patent Application Publication
(10) Pub. No.: US 2019/0236860 A1
(43) Pub. Date: Aug. 1, 2019

(54) TIRE PUNCTURE FEEDBACK SYSTEM

(71) Applicant: Bridgestone Americas Tire Operations, LLC, Nashville, TN (US)

(72) Inventors: Ruben L. Madrid, Copley, OH (US); Justin M. Gehres, Uniontown, OH (US)

(21) Appl. No.: 16/334,776

(22) PCT Filed: Sep. 19, 2017
(86) PCT No.: PCT/US17/52262

§ 371 Date: Mar. 20, 2019

Related U.S. Application Data
(60) Provisional application No. 62/398,153, filed on Sep. 22, 2016.

(51) Int. Cl. G07C 5/06; B60C 23/06; B60Q 1/32; G01M 3/40

(52) U.S. Cl. CPC G07C 5/06; B60C 23/068; G01M 3/40; B60Q 1/326; B60C 23/063

(57) ABSTRACT

The present disclosure is directed to a smart tire puncture feedback system having a camera capable of observing foreign objects embedded in a tire, a proximity sensor, and a processor that can determine how long a foreign object has been embedded in the tire and alert a user after a predetermined period.

### FIELD OF INVENTION

The present disclosure relates to systems for detecting a puncture in a tire. More specifically, the present disclosure includes systems that detect foreign objects embedded in a tire, and alert a driver of the presence of the foreign objects.

### BACKGROUND

When foreign objects become embedded in a tire, they can cause damage to the tire over time if they are not removed. In some instances, drivers may not be aware that an object has become embedded in a tire. For example, some tires produced today include sealant, which prevents the tires from losing air pressure in the event of a puncture. These tires may include Tire Pressure Monitoring Systems (“TPMS”), but the TPMS cannot provide puncture warnings to the driver, because the TPMS systems only detect a change in pressure. Thus, a need exists for detecting foreign objects in a tire that does not rely solely on changes in air pressure.

### SUMMARY

In one embodiment, a puncture detection system for a tire includes a camera mounted in a wheel well of a vehicle, and that can detect light reflected from an object embedded in the tire. The system further includes a proximity sensor and a processor. The processor is in communication with the camera and proximity sensor, and can transmit an alert to a user when the camera detects that a foreign object is embedded within a tire.

The puncture detection system further may include a communications subsystem that can transmit the alert via a hard wired connection or via a direct radio frequency protocol. The system may include an RFID chip that is detected by the proximity sensor, when the RFID chip comes within a certain proximity to the proximity sensor. The processor may transmit the alert when it determines that the foreign object has been present in the tire for a pre-determined number of tire rotations. The camera in this embodiment may further be encased in a protective case, and the system may include a light source which may provide light to a surface of the tire.

In another embodiment, an electromagnetic puncture detection system is designed for a vehicle having a tire with steel cords. The system includes a transducer sensitive to a magnetic field created by the steel cords, and which outputs an electric signal corresponding to the magnitude of the magnetic field. The system further includes a processor configured to receive signals from the transducer and configured to transmit an alert when the electric signal varies outside of a predetermined threshold.

In this embodiment, the electromagnetic puncture detection system may further include a reference table having electrical signal reference data accessible to the processor, and may include an RFID chip and proximity sensor. In this embodiment, the processor may write values into the reference table based on historical data from the magnetic or rotational sensor and the proximity sensor. The system may further include a communications subsystem for transmitting the alert. The magnetic field may be generated by one or more magnets configured to be affixed to the wheel, an electromagnetic motor, or one or more metallic cords located in the tire belt.

In yet another embodiment, a method for detecting a puncture in a tire includes the steps of sensing the presence of a foreign object embedded in a tire, measuring the number of rotations of the tire, and tracking whether the foreign object remains in the tire for a pre-determined number of tire rotations. The method alerts a driver to the presence of the foreign object if the pre-determined number of tire rotations is reached or exceeded.

The step of alerting may be performed with a direct radio frequency protocol, and the sensing step may be performed with an optical sensor. The measuring step may be performed with an RFID chip and a proximity sensor.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a section view of a tire with one embodiment of a system for detecting a foreign object in the tire;

FIG. 2 is a section view of a tire with another embodiment of a system for detecting a foreign object in the tire;

FIG. 3 is a section view of a tire with still another embodiment of a system for detecting a foreign object in the tire; and

FIG. 4 is a section view of a tire with yet another embodiment of a system for detecting a foreign object in the tire.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Tread” refers to that portion of the tire that comes into contact with the road under normal inflation and load.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

While similar terms used in the following descriptions describe common tire components, it is understood that because the terms carry slightly different connotations, one of ordinary skill in the art would not consider any one of the following terms to be purely interchangeable with another term used to describe a common tire component.

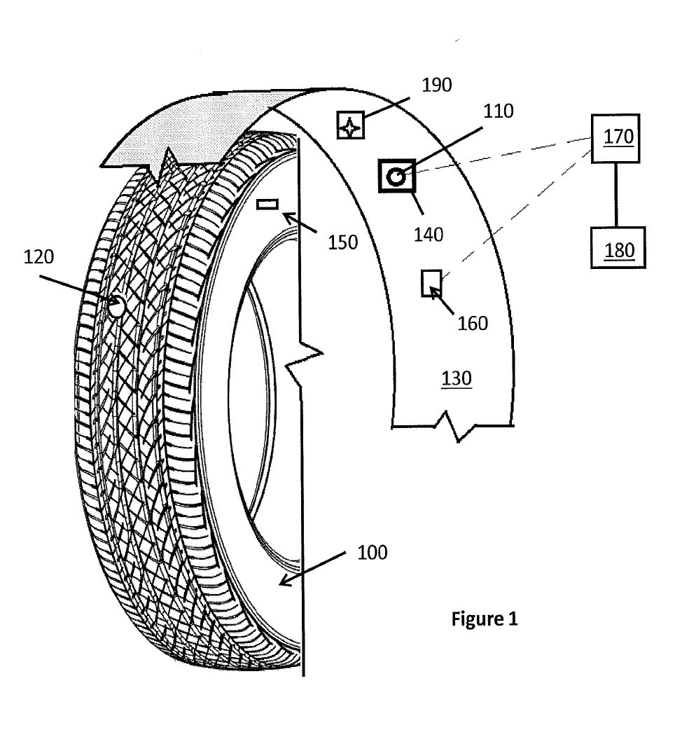

FIG. 1 illustrates a section view of a tire 100 with one embodiment of a system for detecting a foreign object in the tire 100. In the illustrated embodiment a camera 110 detects the presence of an object 120 embedded in the tread of tire 100. Objects 120 that can become embedded into tire 100 include stones, nails, pieces of metal, bolts, plastic, etc.

Tire 100 is shown in a cutaway view within wheel well 130. The camera 110 is mounted in the wheel well 130 of a vehicle, positioned so that it can view the surface of tire 100. The camera 110 in this embodiment is contained within a protective case 140 that protects the camera 110 from being damaged by mud, fluids, stones, other road hazards, and the like. At least a portion of the protective case 140 is transparent so as to not obstruct the camera's range. The camera 110 can be used to detect objects 120 stuck in tire 100 based on the luminosity of the object's light reflection.

This system also includes an electronic device 150 (such as an RFID chip, a transmitter, etc.) attached to tire 100, and a corresponding proximity sensor 160 that can detect when the electronic device 150 passes by the proximity sensor 160. The proximity sensor 160 is connected to a processor 170 to determine the rotational orientation of the tire 100 at a given time. In alternative embodiments, other position tracking systems may be employed. For example, an encoder or other sensors may be employed to track the rotational orientation of an axle or a wheel of the car. The rotational orientation of the tire can then be determined based on the orientation of the axle or wheel.

The proximity sensor 160 and processor 170 are connected to the camera 110 to track how long the object 120 is fixed in the same spot on the tire 100, in terms of the number of tire rotations. For example, the processor 170 obtains information from the proximity sensor 160 and the camera 110 related to the number of tire revolutions and the presence of an object 120, respectively. When the processor 170 calculates that the object 120 has been embedded in the tire 100 for a predetermined length of time, it sends a warning message to the driver. In one embodiment, the predetermined length of time is a fixed number, such as 100 revolutions of the tire 100. In an alternative embodiment, the predetermined length of time may vary according to the size of the object detected, the age of the tire, or other factors.

The warning message can take the form of a light in a display panel of the car. Additionally, or in the alternative, it can be sent as a text, visual, or audible alert to a user's cellphone via a direct radio frequency protocol or via a telephone network, or it can take any number of other forms. To transmit the message, the processor 170 may be connected to a communications subsystem 180 that relays the warning message to the display panel, to a cellphone, or to another location. The communications subsystem 180 could, for example, be hardwired to a display panel of the vehicle, or can communicate wireless through a radio frequency protocol.

A light source 190 may optionally be provided in the wheel well 130, which provides light to a surface of the tire 100. In this way, the puncture detection system works in the absence of a natural light source.

Each component can be powered by an internal battery of the vehicle, from multiple dedicated power sources, or from a single dedicated power source.

In other alternative embodiments (not shown), the protective case around the camera can be omitted. In other alternative embodiments (not shown), a different optical sensor can be used in the place of a camera, including but not limited to an infrared sensor, an x-ray, or a spectrometer. In other alternative embodiments (not shown), other types of wheel speed sensors can be used to track the number of tire revolutions.

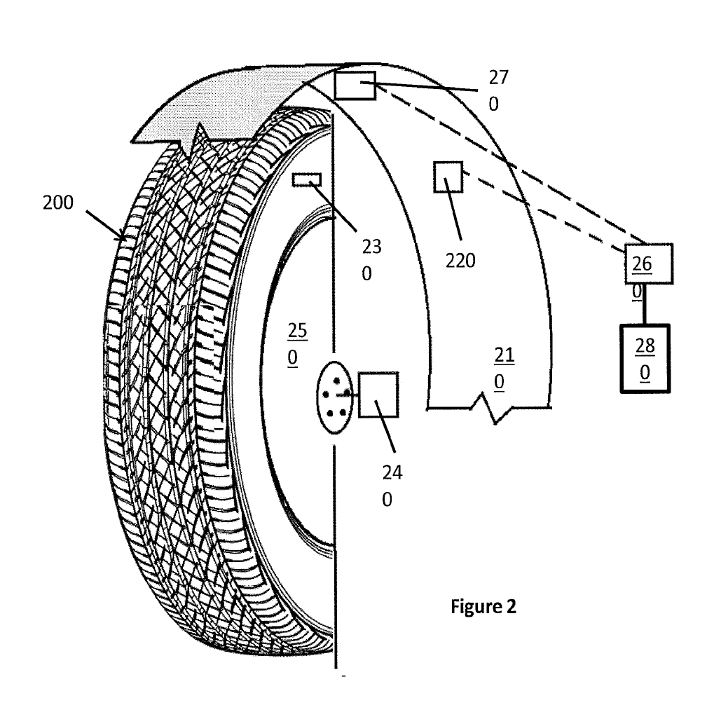

FIG. 2 illustrates a section view of a tire 200 with an alternative embodiment of a system for detecting a foreign object in the tire 200. The tire 200 is located in a wheel well 210, with a speed sensor 220 mounted thereto. An electronic device 230 is mounted to the tire 200. The speed sensor 220 detects the electronic device 230 as it passes by the speed sensor 220.

The electromagnetic system also includes an electromagnetic motor 240 with a shaft connected to wheel 250. The motor 240 is also connected to a processor 260 located either in the wheel area or in another section of the vehicle. The shaft of the motor 240 rotates when the wheel 250 rotates, thereby causing the motor 240 to generate a magnetic field.

A transducer 270 is also located on a top of wheel well 210. The transducer 270 measures the magnetic field generated by the motor 240, and generates an electrical signal corresponding to the magnetic field. The transducer 270 sends the electrical signal to the processor 260.

In alternative embodiments (not shown), the transducer can be mounted to a ring extending around wheel, without rotating about the wheel. In this way, the transducer will remain on a top side of wheel while the wheel rotates.

The processor 260 is also in communication with the speed sensor 220, which allows the processor to determine tire speed based on the frequency of the electronic device 230 passing by the speed sensor 220. The processor 260 has access to a reference table located in a memory (not shown), where the processor writes data indicative of the strength of magnetic fields of the tire 200 at various speeds. The processor populates the reference table during a configuration operation, using information from the transducer 270 about the magnetic fields of the tire at various speeds to write corresponding values into the reference table. Alternatively, the reference table can be pre-populated.

During operation of the vehicle, the speed sensor 220 measures the tire rotational speed and the transducer measures the magnetic field of the tire at that speed. The processor 260 then compares the measured value of the magnetic field to the expected value stored in the reference table for the measured speed. A metallic foreign object in the tire 200 would disturb the magnetic field generated by the motor 240. Therefore, when the processor 260 detects a variance in the magnetic field greater than a pre-determined threshold, it notifies a user using a communications subsystem 280. The communications subsystem 280 could, for example, be hardwired to a display panel of the vehicle, or can communicate wireless through a radio frequency protocol.

In other alternative embodiments (not shown), the shaft of the motor can be connected to the wheel via a linkage or gear system, and the motor can be located remotely from the wheel. In other alternative embodiments (not shown), the transducer can be located in other areas, such as on the wheel hub, wheel rim, or side surface, or can be located on the wheel well.

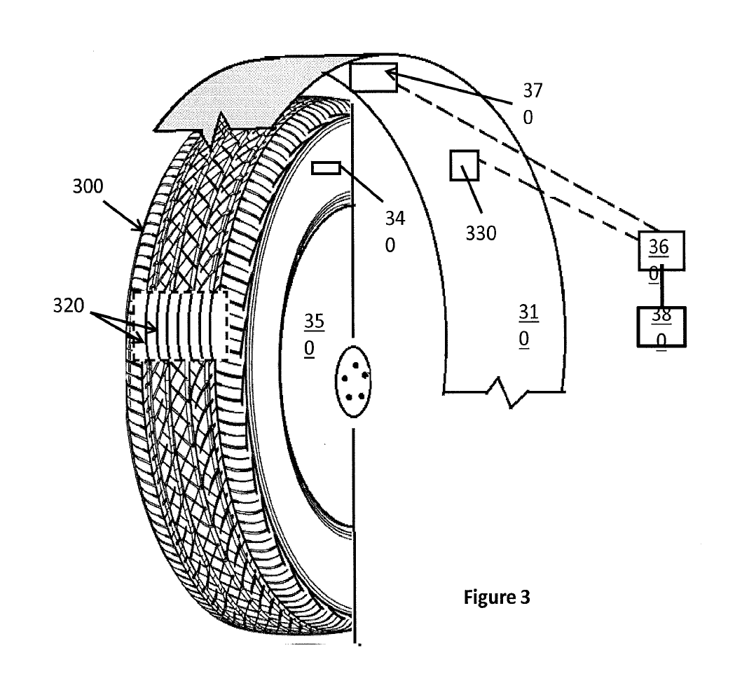

FIG. 3 shows a tire 300 with another alternative system for detecting changes in a magnetic field. In this embodiment, the tire 300 is located in a wheel well 310, and the tire 300 includes a plurality of steel belts 320. A speed sensor 330 is mounted to the wheel well 310. An electronic device 340 is mounted to the tire 310, and the speed sensor 330 detects the presence of electronic device 340 as it passes by the sensor 330. Speed sensor 330 is in communication with processor 360. Processor 360 functions in the same way as processor 260, as discussed above with respect to FIG. 2. In an alternative embodiment (not shown), the electronic device is mounted to a wheel 350.

A transducer 370 is located on wheel well 310, and is in communication with a processor 360. In alternative embodiments (not shown), the transducer can be located in other areas on the wheel, such as on the rim or side surface, or can be located on the wheel well.

In alternative embodiments (not shown), the transducer can be mounted to a ring extending around wheel, which does not rotate with wheel. In this way, the transducer will remain on a top side of wheel while the wheel rotates.

A magnetic field is generated by the rotating belts 320 located in tire 300. The magnetic field may be disturbed by a material becoming lodged in tire 300. Such a disturbance is detected by the transducer 370, which reports the disturbance to processor 360 in the same manner as described above with respect to FIG. 2. A flat tire will also cause a disturbance to magnetic field created by belt 320.

The processor 360 compares the measured value of the magnetic field to the expected value stored in the reference table for the measured speed. When the processor 360 detects a variance in the magnetic field greater than a pre-determined threshold, it notifies a user using a communications subsystem 380. The communications subsystem 380 could, for example, be hardwired to a display panel of the vehicle, or can communicate wireless through a radio frequency protocol.

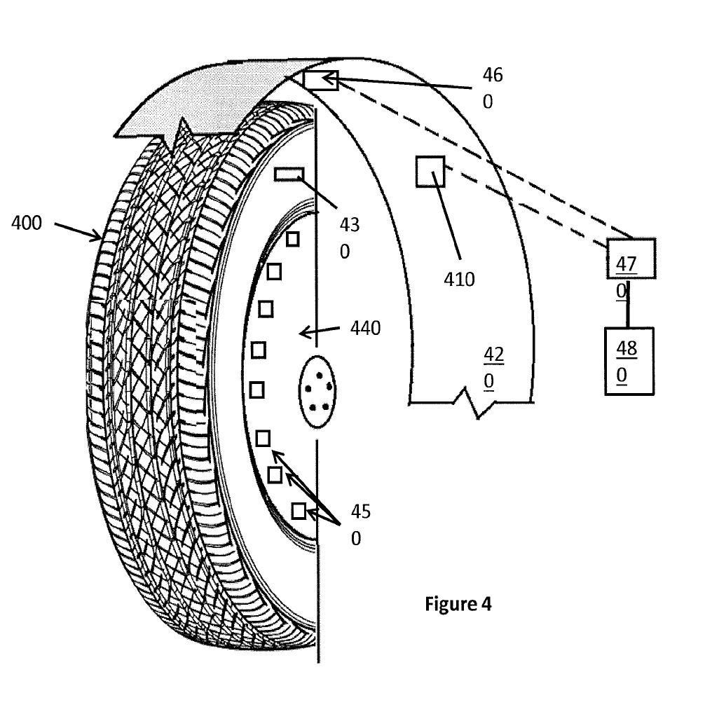

FIG. 4 illustrates a tire 400 with yet another embodiment of a system for detecting changes in a magnetic field. A speed sensor 410 is disposed on a wheel well 420, and an electronic device 430 is disposed in the tire 400. The speed sensor 410 and electronic device 430 function in substantially the same way as described above with respect to FIG. 2.

In this embodiment a wheel 440 includes a plurality of magnets 450 that generate a magnetic field when the wheel is in motion. Magnets 450 can be affixed to the wheel in any manner, including but not limited to welding, use of an adhesive, or mechanically fastened. A transducer 460 is also connected to the wheel 440. The transducer 460 functions in substantially the same manner as described above, and can detect changes in the magnetic field when metal material becomes lodged in tire 400.

The speed sensor 410 and the transducer 460 communicate with a processor 470, which is in signal communication with a communication subsystem 480. The processor 470 and communications subsystem 480 function in substantially the same manner as discussed above.

In alternative embodiments (not shown), any number of magnets can be affixed to wheel, and can be affixed in any location to generate a magnetic field when the tire is in motion. In alternative embodiments (not shown), the transducer can be located in other locations, such as elsewhere on the wheel, in the tire, or on the wheel well.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1-15. (canceled)

16. A puncture detection system for a tire, comprising:
a camera configured to be mounted in a wheel well of a vehicle, the camera being capable of detecting light reflected from a foreign object in the tire;
a proximity sensor; and
a processor in communication with the camera and the proximity sensor, the processor programmed to transmit an alert when the camera detects periodic reflected light from a foreign object in the tire.

17. The puncture detection system of claim 16, further comprising a communications subsystem in communication with the processor for transmitting the alert.

18. The puncture detection system of claim 17, wherein the communications subsystem utilizes a direct radio frequency protocol.

19. The puncture detection system of claim 17, wherein the communications subsystem is hard wired to a display panel in a vehicle.

20. The puncture detection system of claim 16, wherein the tire includes an RFID chip that is detected by the proximity sensor when the RFID chip comes within a certain proximity of the proximity sensor, and,
wherein the processor transmits the alert when it determines that a foreign object has been present in the tire for a pre-determined number of tire rotations.

21. The puncture detection system of claim 16, wherein the camera is enclosed in a protective case.

22. The puncture detection system of claim 16, further including a light source that provides light to the tire.

23. An electromagnetic puncture detection system for a vehicle having at least one wheel and at least one tire including a belt, the system comprising:
a transducer,
wherein the transducer is sensitive to a magnetic field created by a magnetic field source when the tire is in motion and outputs an electric signal corresponding to the magnitude of the magnetic field; and
a processor configured to receive the signal sent from the transducer and transmit an alert when the magnetic field varies outside of a predetermined threshold.

24. The electromagnetic puncture detection system of claim 23, further comprising a reference table containing magnetic field reference data, accessible to the processor.

25. The electromagnetic puncture detection system of claim 24, wherein the tire includes an RFID chip and a proximity sensor that can detect proximity of the RFID chip.

26. The electromagnetic puncture detection system of claim 25, wherein the processor inserts values into the reference table based on historical data from the magnetic field sensor and the proximity sensor.

27. The electromagnetic puncture detection system of claim 23, further comprising a communications subsystem for transmitting the alert.

28. The electromagnetic puncture detection system of claim 23, wherein the magnetic field source is one or more magnets configured to be affixed to the wheel.

29. The electromagnetic puncture detection system of claim 23, wherein the magnetic field source is an electromagnetic motor having a shaft, the shaft of the electromagnetic motor being rotationally fixed to the wheel.

30. The electromagnetic puncture detection system of claim 23, wherein the magnetic field source is one or more metallic cords located in the tire belt.

31. A method for detecting a puncture in a tire comprising the steps of:
sensing the presence of a foreign object embedded in a tire;
measuring the rotations of the tire;
tracking whether the foreign object remains in the tire for a pre-determined number of tire rotations; and
alerting a driver of the presence of the foreign object if the pre-determined number of rotations is reached or surpassed.

32. The method of claim 31, wherein the step of alerting is performed with a direct radio frequency protocol.

33. The method of claim 31, wherein the sensing step is performed with an optical sensor.

34. The method of claim 31, wherein the measuring step is performed with an RFID chip and a proximity sensor.

35. The method of claim 31, wherein the alert is sent to a display panel of a vehicle.
